(19) United States
(12) Patent Application Publication
(10) Pub. No.: US 2005/0096082 A1
(43) Pub. Date: May 5, 2005

(54) Duo-display mobile phone

(76) Inventor: Chin-Wei Chang, Taipei (TW)

Correspondence Address: Alan D. Kamrath;Rider Bennett, LLP, Suite 2000, 333 South Seventh Street, Minneapolis, MN, 55402, US

(21) Appl. No.: 10/700,609

(22) Filed: Nov. 3, 2003

(51) Int. Cl. H04M 1/00

(52) U.S. Cl. 455/550.1; 455/575.3; 455/575.4

(57) ABSTRACT

A duo-display mobile phone is disclosed. The duo-display mobile phone includes a first unit, a second unit movably connected with the first unit, a first display installed at the first unit, a second display installed at the second unit and a button installed at the first unit. The second unit is connected with the first unit in a pivotal or sliding manner.

### FIELD OF INVENTION

The present invention relates to a duo-display mobile phone and, more particularly, a duo-display mobile phone with which it is possible to simultaneously perform multiple tasks.

### BACKGROUND OF INVENTION

This is an era of economy of knowledge. It is important to develop, communicate, store and use knowledge. Telephone, fax and email have been used to communicate knowledge. Telephone devices, fax machines and personal computers are however limited to locations due to use of cables.

Mobile phones have been devised for non-territorial and spontaneous communication.

Most mobile phones provide only a display that renders it difficult, if not impossible, to simultaneously perform multiple tasks with them.

Some mobile phones include a first unit, a second unit pivotally connected with the first unit, a small display installed on a side of the first unit and a large display installed on an opposite side of the first unit. The second unit can be pivoted relative to the first unit between a closed position and an open position. In the closed position, the mobile phones are in a standby situation. Only the small display can be observed. In the open position, the mobile phones can be used. Only the large display can be observed. Therefore, it is difficult, if not impossible, to simultaneously perform multiple tasks with such mobile phones.

The present invention is therefore intended to obviate or at least alleviate the problems encountered in prior art.

### SUMMARY OF INVENTION

The primary objective of the present invention is to provide a duo-display mobile phone with which it is possible to simultaneously perform multiple tasks.

According to the present invention, a duo-display mobile phone is disclosed. The duo-display mobile phone includes a first unit, a second unit movably connected with the first unit, a first display installed at the first unit, a second display installed at the second unit and a button installed at the first unit.

The second unit may be connected with the first unit in a pivotal manner.

The second unit may be connected with the first unit in a sliding manner.

Other objects, advantages and novel features of the invention will become more apparent from the following detailed description in conjunction with the attached drawings.

### BRIEF DESCRIPTION OF DRAWINGS

The present invention will be described via detailed illustration of embodiments referring to the drawings.

FIG. 1 is a perspective view of a duo-display mobile phone according to a first embodiment of the present invention.

FIG. 2 shows the duo-display mobile phone of FIG. 1 in a different position.

FIG. 3 is a perspective view of a duo-display mobile phone according to a second embodiment of the present invention.

FIG. 4 shows the duo-display mobile phone of FIG. 3 in a different position.

FIG. 5 is a perspective view of a duo-display mobile phone according to a third embodiment of the present invention.

FIG. 6 shows the duo-display mobile phone of FIG. 5 in a different position.

FIG. 7 is a perspective view of a duo-display mobile phone according to a fourth embodiment of the present invention.

FIG. 8 shows the duo-display mobile phone of FIG. 7 in a different position.

### DETAILED DESCRIPTION OF EMBODIMENTS

According to the present invention, a duo-display mobile phone includes a first unit, a second unit movably connected with the first unit, a first display installed at the first unit, a second display installed at the second unit and a button installed at the first unit. The duo-display mobile phone accordingly the present invention is particularly useful when used as a 3G mobile phone, i.e., a mobile phone capable of operating with GSM 900, GSM 1800 and GPRS.

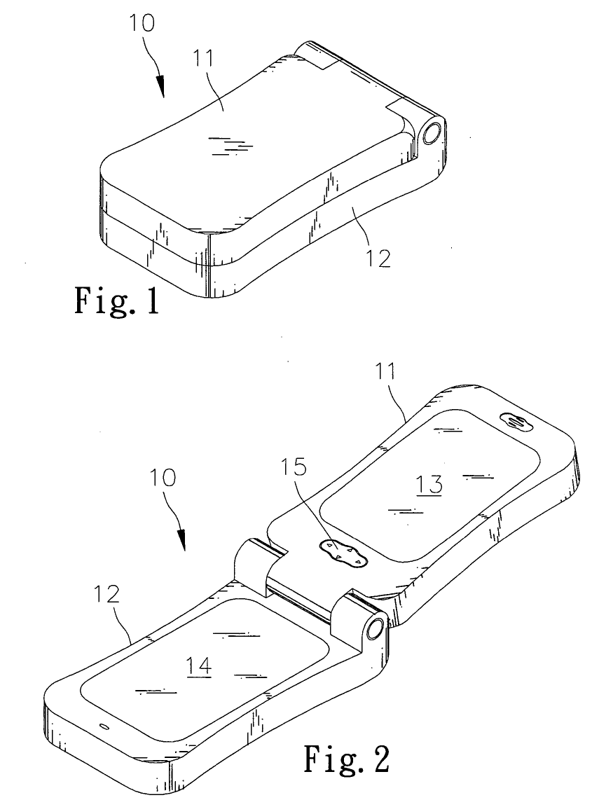

FIGS. 1 and 2 show a duo-display mobile phone 10 according to a first embodiment of the present invention. The duo-display mobile phone 10 includes a first unit 11, a second unit 12 pivotally connected with the first unit 11, a first display 13 installed at the first unit 11, a second display 14 installed at the second unit 12 and a four-way button 15 installed at the first unit 11.

The duo-display mobile phone 10 can be pivoted between a first position shown in FIG. 1 and a second position shown in FIG. 2. In the first position, the first unit 11 and the second unit 12 cover each other, i.e., the first display 13 and the second display 14 cannot be observed and the four-way button 15 cannot be operated. In the second position, the first unit 11 and the second unit 12 do not cover each other, i.e., the first display 13 and the second display 14 can be observed and the four-way button 15 can be operated.

The first display 13 is used to show signal condition, battery capacity, time, background patterns, etc. The first display 13 is like the display in any conventional mobile phone and therefore will not further be described in detail.

The second display 14 can be used as a display and an input device. To this end, the second display 14 is a touch panel.

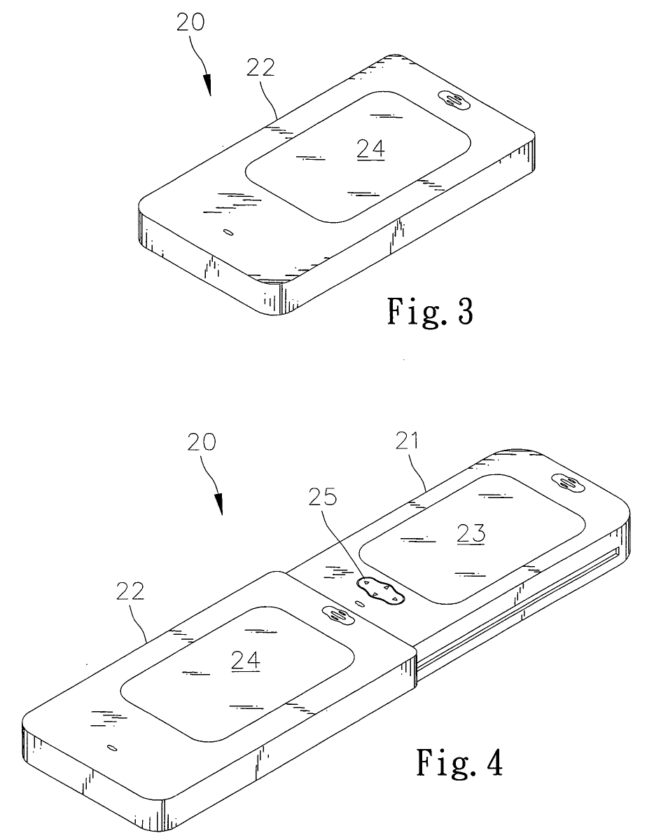

FIGS. 3 and 4 show a duo-display mobile phone 20 according to a second embodiment of the present invention. The duo-display phone 20 includes a first unit 21, a second unit 22 movably mounted on the first unit 21, a first display 23 installed at the first unit 21, a second display 24 installed at the second unit 22 and a four-way button 25 installed at the first unit 21.

The second unit 22 is configured as a sliding cover for the first unit 21. The second unit 22 can be moved relative to the first unit 21 between a first position shown in FIG. 3 and a second position shown in FIG. 4. In the first position, the first unit 21 is covered by means of the second unit 22. Thus, the first display 23 cannot be observed and the four-way button 25 cannot be operated. In the second position, the first unit 21 is not covered by means of the second unit 22. Thus, the first display 23 can be observed and the four-way button 25 can be operated. The second embodiment is otherwise identical to the first embodiment and therefore will not further be described in detail.

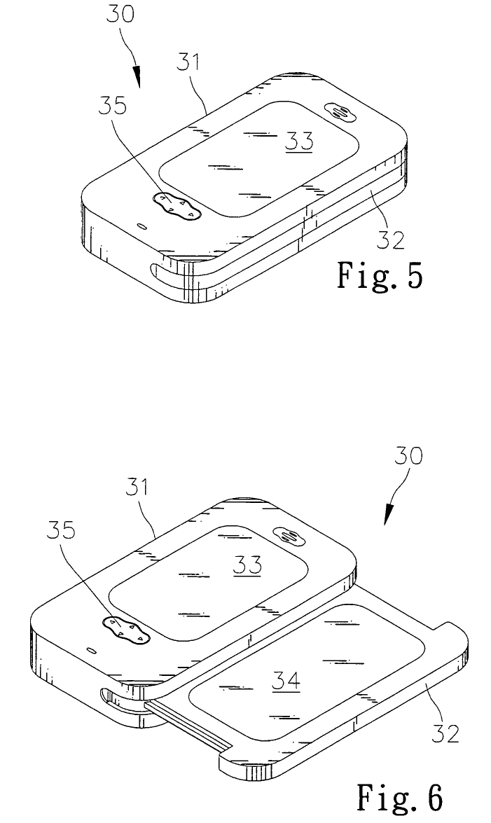

FIGS. 5 and 6 show a duo-display mobile phone 30 according to a third embodiment of the present invention. The duo-display phone 30 includes a first unit 31, a second unit 32 that can be inserted into a space defined in the first unit 31, a first display 33 installed at the first unit 31, a second display 34 installed at the second unit 32 and a four-way button 35 installed at the first unit 31.

The second unit 32 is movable relative to the first unit 31 in a transverse direction. The second unit 32 is movable relative to the first unit 31 between a first position shown in FIG. 5 and a second position shown in FIG. 6. In the first position, the first unit 31 covers the second unit 32. Thus, the second display 34 cannot be observed. In the second position, the first unit 31 does not cover the second unit 32. Thus, the second display 34 can be observed. The third embodiment is otherwise identical to the first embodiment and therefore will not further be described in detail.

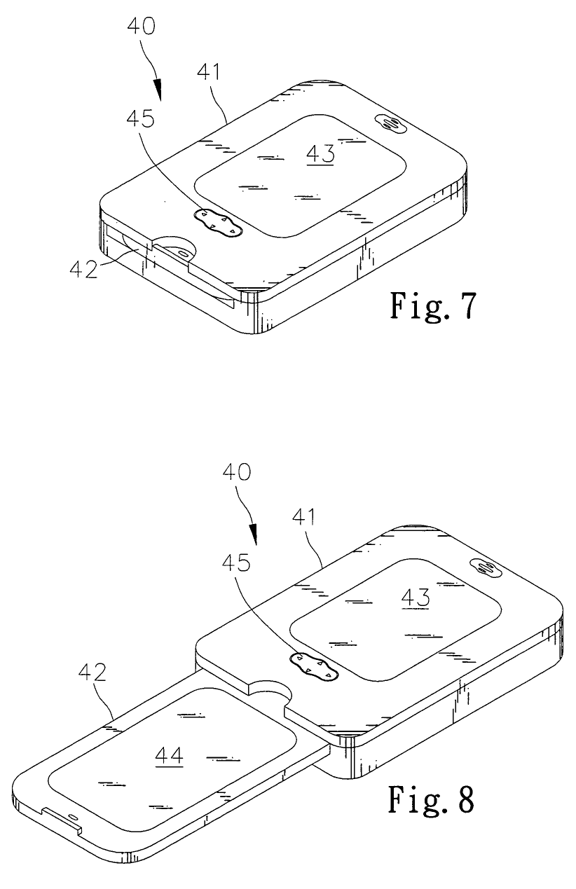

FIGS. 7 and 8 show a duo-display mobile phone 40 according to a fourth embodiment of the present invention. The duo-display phone 40 includes a first unit 41, a second unit 42 movably connected with the first unit 41, a first display 43 installed at the first unit 41, a second display 44 installed at the second unit 42 and a four-way button 45 installed at the first unit 41.

The fourth embodiment is identical to the third embodiment except that the second unit 42 is movable relative to the first unit 41 in a transverse direction. Therefore, the fourth embodiment will not further be described in detail.

Various operational modes of the duo-display mobile phone 10, 20, 30 or 40 will be described.

When the duo-display mobile phone is in a standby situation, the second display shows screen-protective motion pictures. To use the duo-display mobile phone, a user touches the second display or operates the four-way button so as to have the second display show icons representing functions available. To protect the second display, the user would better touch it with a pen (not shown) specialized for contact with a touch panel without causing any damage to the touch panel. The user can perform the functions via touching the icons shown on the second display or operating the four-way button.

In a first mode, the user can use the duo-display mobile phone to make a phone call. The second display 14 shows numerals, an icon for dialing and an icon for hanging up so that the user can dial and get connected, or hang up. If the duo-display mobile phone is equipped with a hand-free device, the user can have the first display show the photograph of a person in a phone call with him or her, and have the second display show a schedule, a phone book, news or a message at the same time.

In a second mode, the user can make a three-party phone call with the duo-display mobile phone. The user can have the first display show the photograph of a first person in a phone call with him or her, and have the second display show the photograph of a second person in a phone call with him or her.

In a third mode, the user can have the first display show a message that he or she received, and have the second display show a message that he or she is writing.

In a fourth mode, the user can play Kara-OK with the duo-display mobile phone. The user can have the first display show a list of songs available or ordered and the second display show a motion picture for a song.

In a fifth mode, the user can play a game with the duo-display mobile phone. The user can have the second display show a main screen of the game, and have the first display show a divisional screen of the game.

In a sixth mode, the user can play a motion picture with the duo-display mobile phone. The user can have the second display show a main screen of the motion picture, and have the first display show a divisional screen of the motion picture.

In a seventh mode, the user can play a motion picture with the duo-display mobile phone. The user can have first display show the motion picture, and have the second display show icons representing functions available such as “play”, “pause”, “stop”, “fast forward”, “fast backward”, “open an old file”, “show a window”, etc.

In an eighth mode, the user can have the first display show information about work such as a schedule, and have the second display show information about entertainment such as a motion picture.

In a ninth mode, the user can use the duo-display mobile phone as an electronic book. The user can have the first display show a page of the book, and have the second display show another page of the book.

In a tenth mode, the user can use the duo-display mobile phone as an electronic dictionary. The user can have the first display show an article in its original language, and have the second display show its translation.

In an eleventh mode, the user can use the duo-display mobile phone as an electronic album. The user can have the first display show a photograph, and have the second display show another photograph.

In different applications, the first display and the second display can selectively show information in a longitudinal or transverse manner. When the second display shows information in the transverse manner, it shows a 16:9 screen.

The present invention has been described via detailed illustration of some embodiments and modes of operation. Those skilled in the art can derive variations from the embodiments and the modes of operation without departing from the scope of the present invention. Therefore, the embodiments and the modes of operation shall not limit the scope of the present invention defined in the claims.

1. A mobile phone comprising:
a first unit;
a second unit movably connected with the first unit;
a first display installed at the first unit;
a second display installed at the second unit so that the first display and the second display can simultaneously be observed when the mobile phone is in operation; and
a button installed at the first unit.

2. The mobile phone according to claim 1 wherein the second display can be used as an input device.

3. The mobile phone according to claim 2 wherein the second display is a touch panel.

4. The mobile phone according to claim 1 wherein the button is a four-way button.

5. The mobile phone according to claim 1 wherein the first display can show information in a longitudinal manner.

6. The mobile phone according to claim 1 wherein the second display can show information in a transverse manner.

7. The mobile phone according to claim 1 wherein the second unit is pivotally connected with the first unit.

8. The mobile phone according to claim 1 wherein the second unit is connected with the first unit in a sliding manner.

9. The mobile phone according to claim 8 wherein the second unit is mounted on the first unit in a sliding manner.

10. The mobile phone according to claim 9 wherein the second unit is movable relative to the first unit in a longitudinal direction.

11. The mobile phone according to claim 8 wherein the first unit defines a space into which the second unit can be inserted in a sliding manner.

12. The mobile phone according to claim 11 wherein the second unit is movable relative to the first unit in a transverse direction.

13. The mobile phone according to claim 11 wherein the second unit is movable relative to the first unit in a longitudinal direction.
